(19) United States
(12) Patent Application Publication
(10) Pub. No.: US 2008/0217219 A1
(43) Pub. Date: Sep. 11, 2008

(54) SCREENING APPARATUS, IN PARTICULAR, A SPECIFIC RESONANCE SCREENING APPARATUS FOR HARD-TO-SEPARATE CRUDE OIL SAND MIXTURES

(75) Inventors: Ralph NABERG, Vallauris (FR); Udo Artur ZOLLNER, Sengenthal-Buchberg (DE)

Correspondence Address: BROWDY AND NEIMARK, P.L.L.C.;624 NINTH STREET, NW, SUITE 300, WASHINGTON, DC, 20001-5303, US

(73) Assignee: Paul GmbH & Co. KG, Steinau (DE)

(21) Appl. No.: 11/851,728

(22) Filed: Sep. 7, 2007

(30) Foreign Application Priority Data
Sep. 7, 2006 (DE) 102006041989.8

(51) Int. Cl. B07C 5/36

(52) U.S. Cl. 209/698; 209/606

(57) ABSTRACT

A screening apparatus, in particular for mixtures, which are difficult to separate, as e.g. crude oil sand mixtures, comprising
a base support frame, aligned substantially horizontally, supported relative to the support floor through damping springs as an opposite oscillating mass;
several inclined energy storage spring packages, each provided as a double coil spring assembly, carrying a screening box as an oscillating mass; and
several unbalanced mass motors, flanged to the base support frame, imparting an oriented box oscillation with an effective K_{V} value of 9.5 upon the base support frame and through the energy storage spring packets upon the sieve box.

### BACKGROUND OF THE INVENTION

1. Field of the Invention

The invention relates to a screening apparatus, in particular, a specific resonance screening apparatus for hard-to-separate crude oil sand mixtures.

The background of the invention is described in more detail with reference to said crude oil sand mixtures. Thus, in geological layers with a high sand content, a substantial amount of oil silt is created in the process of crude oil extraction, wherein said silt is mixed with a high sand content. In order to be able to also use the crude oil contained in said oil silt, it is necessary to separate the fine sand from the oil silt, so that substantially sand free crude oil is generated as a result of this separation process.

2. Background Art

The separation of such highly viscous crude oil sand mixtures is performed with known screening apparatuses, whose sieve acceleration reaches a maximum 6.35 g. Such screening apparatuses generally have a sieve box as an oscillating mass, which is supported through damping springs in an oscillating manner, relative to the support floor. The sieve oscillation is generated through unbalanced mass motors flanged to the sieve box.

A high sieve acceleration, also designated as sieving coefficient K_{V}, is necessary in particular for fine screening, wherein low mass particles, which are thrown upward due to the sieve oscillation, are pressed through the separation openings of the sieve floor, when falling back in the direction of the advancing sieve floor. The larger the sieving coefficient K_{V}, the larger the specific throughput capacity, this means that the screening performance per sieve area is proportional to the K_{V} factor.

For separating sands from oil silt, so far no satisfactory values have been accomplished, which according to persons skilled in the art is primarily due to the sieving coefficient. The maximum sieving coefficient, which is known to have been reached, is, as discussed a value of maximally 6.35 g, which is too low for the said crude oil sand mixtures.

It is understood that the sieve acceleration, or sieving coefficient of a screening apparatus is to be designed, so that the mean sieve rotation range is approximately 360°, or an integer multiple thereof. This is necessary, so that the falling particle hits the sieve floor in the moment, when said sieve floor has reached its maximum opposite velocity in upward direction. Through the impact velocity between the particles and the sieve bottom, which is also at a maximum at this point, a very effective separation of solid particles is performed, which can also be very fine, e.g. also from very highly viscous media.

An increase of the sieving coefficient above the value of 6.35 g, corresponding to 2×360°=720°, currently reached in typical screening apparatuses, is only useful, when the next sieve rotation angle range of 3×360°=1080° is reached. The associated sieving coefficient K_{V}=9.5. All intermediary K_{V} values only allow reduced screening capabilities.

### SUMMARY OF THE INVENTION

Based on the described issues, the invention is based on the object to refine a screening apparatus with respect to its base design, so that a significant increase of the sieving coefficient can be accomplished up to a range of K_{V}=9.5 g.

This object is accomplished through the design of a screening apparatus, in particular for mixtures, which are difficult to separate, as e.g. crude oil sand mixtures, comprising
a base support frame, supported relative to the support floor through damping springs in an oscillating manner, as a counter oscillating mass;
several inclined energy storage spring packages in the form of a double coil spring assemblies, supported at the base frame, said spring packets, carrying a sieve box as an oscillating mass; and
several motors with unbalanced masses, flanged to the base support frame, imparting an oriented sieve oscillation with an effective K_{V} value of 9.5 upon the base support frame and through the energy storage spring packets upon the sieve box.

With this design the invention departs from the direct acceleration of the sieve box through the oscillating support of said sieve box, relative to the support floor and the motors with unbalanced masses mounted directly thereon, used so far. Furthermore, energy storage springs are being used for energy transfer between the oscillating partners, which do not have the mechanical limitation of stop buffers, guidance elements, and suspension arms between the oscillating partners, as it is the case e.g. in DE 11 87 897 A or DE 68 11 940 U. This was the reason that the state of the art screening apparatuses were limited to a K_{V} value of 5 g to 6 g. The solution according to the invention thereby provides for the combination of two oscillating masses, thus the direct oscillating mass provided as a sieve box and an opposite oscillating mass, provided as a base support frame, which is supported through damping springs relative to the support floor in an oscillating manner. The idea behind this setup is to accelerate the base support frame as an excitation mass tip to approximately 3 g, and to increase the acceleration of the sieve box in connection with the energy storage spring packets, based on its oriented sieve oscillation into the range of effective 10 g. This acceleration breaks down into a K_{V} value of approximately 9.5 g, due to the inclination of the oscillation angle on the sieve floor. Double spring assemblies are being used as energy storage springs, which are energy efficient in particular, since they have low damping and since they can operate with highly increased forces. Additionally this effect can be greatly drastically increased through a preloading of the coil springs.

In the following, preferred refinements of the screening apparatus are provided, in particular, from a design point of view. In order to describe their features, details and advantages, the subsequent description is referred to, in which an embodiment of the object of the invention is described in more detail, based on the appended drawings.

### BRIEF DESCRIPTION OF THE DRAWINGS

FIG. 1 shows an illustration in principle of the contexts between critical sieve rotation angles and the sieving coefficient K_{V};

FIG. 2 shows a perspective view of a screening apparatus; and

FIGS. 3-5 show a lateral view, top view and front view, of the screening apparatus, according to FIG. 2.

### DESCRIPTION OF THE PREFERRED EMBODIMENT

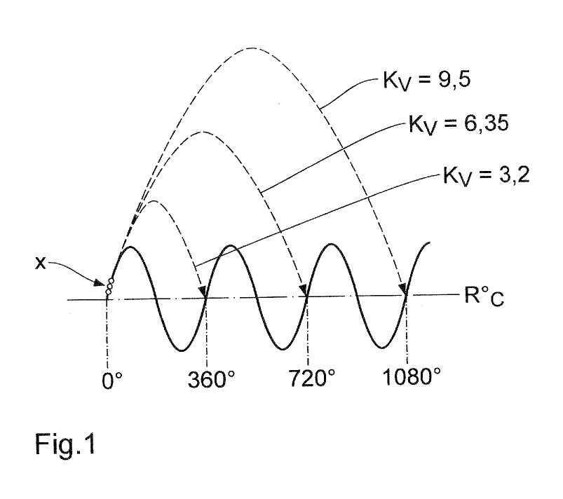

In FIG. 1 the sieve bottom of a screening apparatus is indicated in dashed lines with points, performing a sinusoidal oscillation, defined by the solid line. The maximum velocity of the sieve bottom in vertical direction occurs at the zero transition of the sieve oscillation. From a screening technology point view, thus only the zero transition in upward direction is useful. The throw parabola of particles x for increasing sieving coefficients with the values of 3.2 g, 6.35 g, and 9.5 g is shown in dashed lines in FIG. 1. The throw distance depends on the particular machine acceleration K, the throw angle α, and the sieve inclination β. These three values are defined according to the known formula:

K_{V}=[K sin(α+β)]/cos β.

As mentioned above, a grid coefficient K_{V}=9.5 g is associated with a sieve rotation angle R°_{C}=1080.

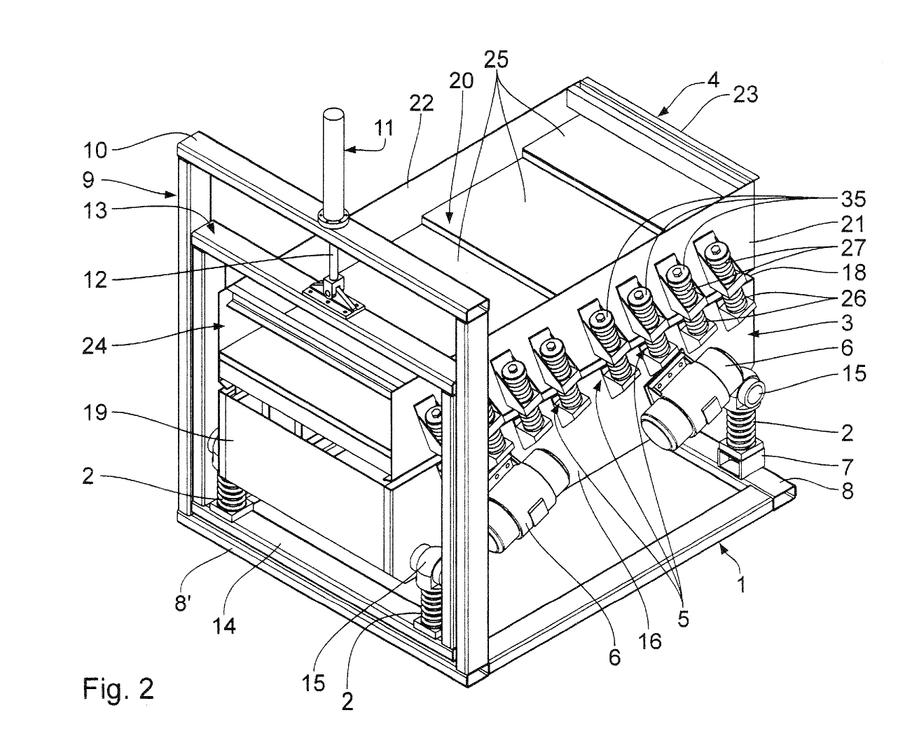

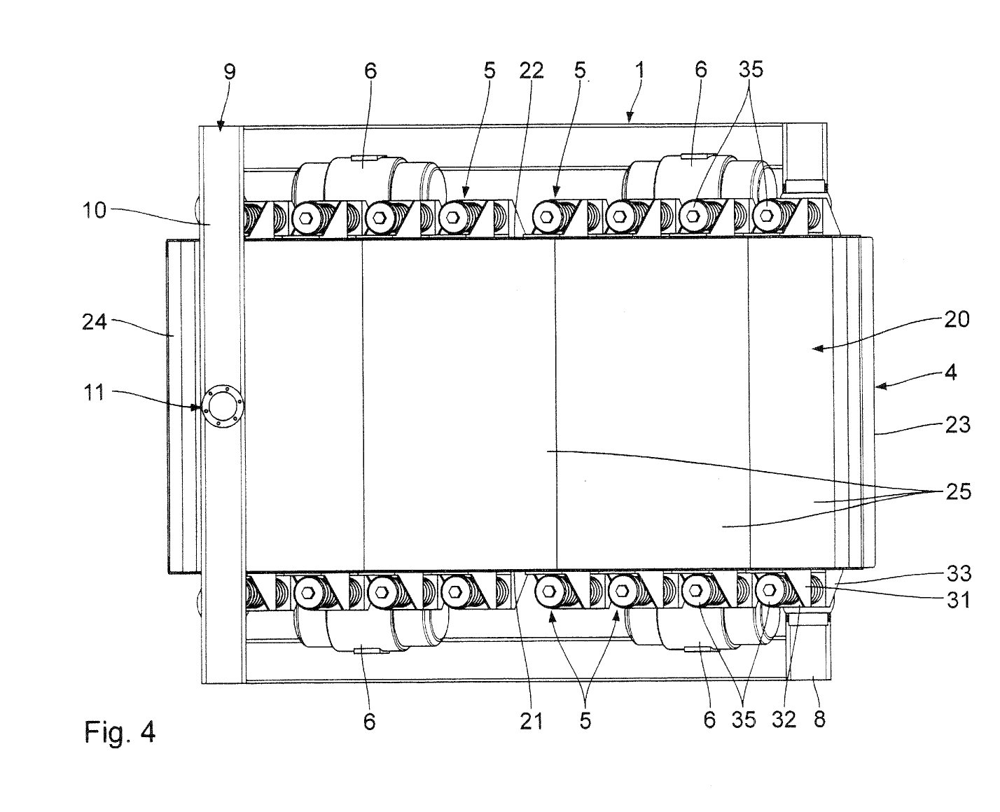

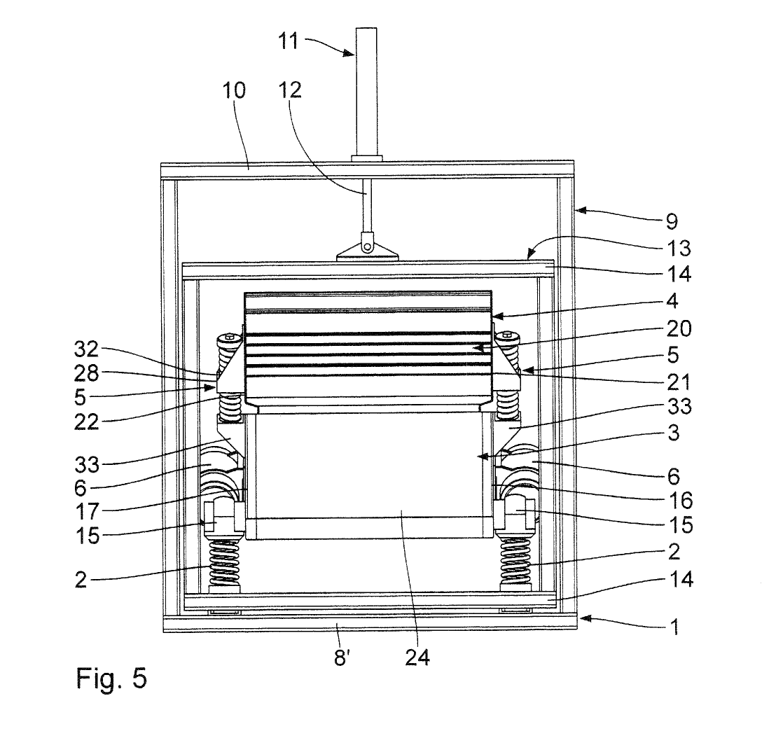

The screening apparatus shown in FIGS. 2 through 5 has the engineered capability to reach such a high sieving coefficient. For this purpose, it has a base frame 1, damping springs 2, a base support frame 3, a sieve box 4, motors with unbalanced masses 6, and energy storage spring packets 5, disposed between the base support frame 3 and the sieve box 4 as basic design elements.

The damping springs 2, positioned in the rear with reference to FIG. 2, are supported through a footing 7 on the rear cross beam 8 of the base frame 1. On the front lateral beam 8′ of the base frame, a vertically superimposed carrier bridge 9 is constructed, at whose horizontal cross beam 10 a vertically operating piston cylinder drive 11 is disposed. At its piston rod 12, an elevation adjustable lifting frame 13 is mounted, at whose bottom cross beam 14, the two front support springs 2 of the base support frame 3 are supported. The connection of the four damper springs 2 at the base support frame 3 is performed respectively through a pivot bearing 15, whose pivot axis extends horizontally in transversal direction.

The base support frame 3, itself is substantially formed by two vertically positioned lobes, forming the longitudinal side pieces 16, 17, and two lobes, connecting the vertical lobes in lateral direction at their ends, forming the transversal side pieces 18, 19. Through the frame opening of the base support frame 3, confined thereby, the fine screening material, falling downward through the sieve bottom 20 of the sieve box 4, can be trans-ported away through a transportation mechanism, which is not shown in more detail here.

The sieve box 4, which basically corresponds to the base support frame 3 in its plan form, is confined by vertically oriented lobes at two longitudinal sides 21, 22, and the rear transversal side 23, with reference to FIG. 2. The sieve box 4 is open at the front transversal side 24, so that the coarse screening material, which has not passed through the sieve bottom 20 there, can be moved away from the sieve bottom 20. The sieve bottom 20, itself is formed by incrementally offset sequentially aligned sieve inserts 25, whose sieves, which are not shown in detail, have a mesh width of approximately 5 μm, as it is necessary for separating fine sand from oil silt.

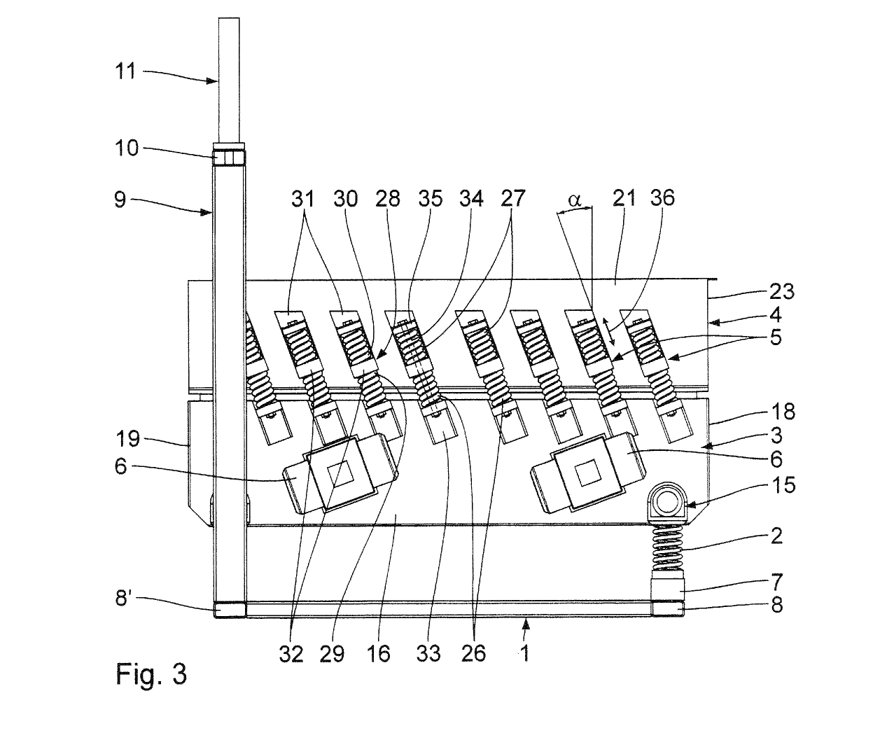

As it is apparent in particular from the FIGS. 2 and 3, the sieve box 4 is mounted to the base support frame 3 above the base support frame 3 through eight respective energy storage spring packets 5, which are distributed over its longitudinal sides 21, 22 at a vertical distance, facilitating the sieve oscillation. These energy storage spring packages 5 are formed by a respective double spring assembly, comprising pairs of coaxially aligned coil springs 26, 27, with their heads 29, 30 next to each other, wherein the sieve box 4 is clamped respectively with a box mounted support 28, between the pairs of associated heads 29, 30 of the coil springs 26, 27. Each support 28 is therefore formed through a support console 31 with a clamping support flange 32, laterally protruding from the sieve box.

The support springs 26, 27 are thus preloaded, allowing an increase of the oscillation amplitude of the sieve box 4, by the triple amount relative to the base support frame 3. Thus, the desired high K_{V}-value of 9.5 g can be reached.

In order to connect the support springs 26, 27 to the base support frame 3, the latter has laterally protruding support consoles 33, disposed at its longitudinal sides 16, 17, wherein on said support consoles the respective lower coil springs 26 are supported. A support bar 34 is coupled to, and reaches vertically upward from the support frames 33, said support bar is drawn in dashed lines in FIG. 3 and has an opposite support 35, shaped as a cover, placed onto its free end. The support bar 34 reaches through the clamping support flange 32 of the support console 31 of the sieve box 4 with a lateral clearance.

The upper coil spring 26 of each energy storage spring packet 5 is clamped between this clamping support flange 32 and the opposite support 35.

The motors 6 with unbalanced masses, protruding outward from and flanged to the two longitudinal sides 16, 17 of the base support frame 3, now put the base support frame 3 into a base oscillation with a sieving coefficient of approximately 3 g during the operation of the screening apparatus. The motion energy of the base support frame 3 is transmitted to the energy storage spring packets 5, which in turn put the sieve box 4 into a sieve oscillation with the desired 10 g, with further increased oscillation energy. The base support frame 3 thereby functions as an opposing oscillation mass for the sieve box 4, acting as an oscillation mass. Through the design of the spring constants of the coil springs 26, 27, and the damping springs 2, the desired screening properties are optimized for the respective masses of the sieve box 4 and the base support frame 3.

As it becomes apparent from FIG. 3, the energy storage spring packets 5 are defined with their spring orientation 36 at a small acute angle α, optimally approximately 20° to vertical, defining the throw angle of the sieve box 4. The thrust line of the unbalanced mass motor 6 is thus aligned in the same direction as the spring packets 5. Through the elevation adjustable lift frame 13, the sieve inclination angle can be adjusted as such.

What is claimed is:

1. A screening apparatus, in particular for mixtures, which are difficult to separate, as e.g. crude oil sand mixtures, comprising
a base support frame (3), aligned substantially horizontally, supported relative to a support floor through damping springs (2) as a counter oscillating mass;
several inclined energy storage spring packages (5), each provided as a double coil spring assembly, carrying a sieve box (4) as an oscillating mass; and
several unbalanced mass motors (6), flanged to the base support frame (3), imparting an oriented sieve oscillation with an effective K_{V} value of 9.5 upon the base support frame (3) and through the energy storage spring packets (5) upon the sieve box (4).

2. A screening apparatus according to claim 1, wherein the damping springs (2) are disposed at the ends of longitudinal sides (16, 17) of the base support frame (3), respectively.

3. A screening apparatus according to claim 2, wherein the damping springs (2), disposed at opposing longitudinal ends of the two longitudinal sides (16, 17), are supported, so that they can be adjusted in elevation.

4. A screening apparatus according to claim 3, wherein the elevation adjustment is formed through a lifting frame (13), supporting the damping springs (2).

5. A screening apparatus according to claim 1, wherein a plurality of energy storage spring packets (5) is lined up along two longitudinal sides (16, 17; 21, 22) of the base support frame (3) and the sieve box (4).

6. A screening apparatus, according to claim 1, wherein the energy storage spring packets (5) are formed by a respective double spring assembly, comprised of coil springs (26, 27), aligned in pairs coaxial head to head, with their ends facing away from each other and mounted to the base support frame (3) in a rigid manner, wherein the sieve box (4) is clamped together with a box mounted support (28) respectively, between heads (29, 30), associated in pairs, of the coil springs (26, 27).

7. A screening apparatus according to claim 1, wherein the double coil spring assembly (5) has respective coil springs, which are preloaded in resting position.

8. A screening apparatus according to claim 5 wherein the energy storage spring packets (5) are disposed with their spring axes at a small acute angle α of approximately 20°, relative to vertical.

9. A screening apparatus according to claim 6, wherein the supports (28), clamped between the coil springs (26, 27), for the sieve box (4) are formed by a support console (31) respectively, with a clamping support flange (32) protruding from the sieve box (4).

10. A screening apparatus according to claim 6, wherein the support of the two coils springs (26, 27) of an energy storage spring packet (5) is formed at the base support frame (4) on the one hand through a support console (33) at the base support frame (4), and on the other hand through an opposite support (35), which is coupled to the support console (33) in a rigid manner by a holding rod (34), extending through an interior of the coil springs (26, 27).

11. A screening apparatus according to claim 1, wherein a pair of unbalanced mass motors (6) is disposed at each longitudinal side (16, 17) of the base support frame in oscillating direction.

12. A screening apparatus according to claim 1, wherein the unbalanced mass motors (6) are aligned with their thrust lines in parallel to the alignment of the energy storage spring packets (5).
